(19) United States
(12) Patent Application Publication
(10) Pub. No.: US 2026/0290683 A1
(43) Pub. Date: Sep. 24, 2026

(54) AIR-CELL RUPTURE DIAGNOSIS METHOD AND SYSTEM

(71) Applicant: Fortune Electric Co., Ltd., Taoyuan City (TW)

(72) Inventors: CHIA-CHING LIN, Taoyuan City (TW); CHING-MIN CHEN, Taoyuan City (TW)

(21) Appl. No.: 19/396,353

(22) Filed: Nov. 21, 2025

(30) Foreign Application Priority Data
Mar. 21, 2025 (TW) 114110667

(51) Int. Cl. H01F 27/40; H01F 27/14

(52) U.S. Cl. CPC H01F 27/402; H01F 27/14; H01F 27/404

(57) ABSTRACT

An air-cell rupture diagnosis method and system used for rupture early warning of an air cell in an oil storage device of a transformer. The air-cell rupture diagnosis system includes a sensing module, an analysis device, and a diagnosis device. The sensing module is disposed on the oil storage device to acquire status information of the oil storage device within at least one unit time interval. The analysis device is connected to the sensing module to establish a data correlation based on the status information. The data correlation defines a conversion relationship between air parameter and oil temperature. The diagnosis device is connected to the analysis device to perform rupture early warning for the air cell during operation of the transformer according to the conversion relationship between air parameter and oil temperature.

### CROSS-REFERENCE TO RELATED PATENT APPLICATION

This application claims the benefit of priority to Taiwan Patent Application No. 114110667, filed on March 21, 2025. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a component rupture diagnosis method and system, and more particularly to an air-cell rupture diagnosis method and system for a transformer.

### BACKGROUND OF THE DISCLOSURE

An oil-immersed transformer is a common piece of power equipment used to decrease a high voltage to a low voltage or increase a low voltage to a high voltage. The stable operation of the oil-immersed transformer is directly related to power supply reliability of an electrical grid. The main feature of the oil-immersed transformer is that an iron core and windings are immersed in an insulating oil to improve insulation performance and prevent failure or ignition of electrical equipment. Furthermore, the insulating oil can effectively dissipate heat, so that the oil-immersed transformer can be maintained at a relatively stable temperature, thereby improving operation efficiency and lifespan.

In order to prevent the insulating oil from coming into contact with moisture in the air, causing oil degradation, an air cell (e.g., a rubber bladder) is installed inside the oil tank to isolate the insulating oil from the atmosphere. However, the air cell may become more prone to rupture as its service life decreases. A rupture at the interface between the air cell and the insulating oil may allow the insulating oil to enter the interior of the air cell, causing a false oil level and posing potential safety risks to transformer operation.

There are currently no means for promptly detecting air cell rupture abnormalities in the relevant art, since oil is required to be completely drained from the oil tank for manual inspections to be performed, which take a lot of time and effort and may also affect the stability of power system supply.

### SUMMARY OF THE DISCLOSURE

In response to the above-referenced technical inadequacies, the present disclosure provides an air-cell rupture diagnosis method and system, which can be used to monitor operating status of an air cell in an oil storage device of a transformer, including intake status and exhaust status, and to promptly detect a rupture abnormality of the air cell, thereby performing early warning and responsive actions.

In order to solve the above-mentioned problems, one of the technical aspects adopted by the present disclosure is to provide an air-cell rupture diagnosis method for an oil storage device of a transformer, which includes an insulating oil and an air cell configured to isolate the insulating oil from the atmosphere. The air-cell rupture diagnosis method includes: acquiring status information of the oil storage device within at least one unit time interval, the status information including exhaust data of the air cell and oil temperature data of the insulating oil; establishing a data correlation based on the status information, the data correlation defining a conversion relationship between air parameter and oil temperature; and performing rupture early warning for the air cell during operation of the transformer according to the conversion relationship between air parameter and oil temperature.

In one of the possible or preferred embodiments, the process of performing the rupture early warning for the air cell includes: determining whether the air cell has a rupture abnormality according to the conversion relationship between air parameter and oil temperature, wherein the air parameter is exhaust pressure or flow rate; and issuing an early warning message when the air cell is determined to have the rupture abnormality.

In one of the possible or preferred embodiments, the at least one unit time interval includes N unit time intervals, where N is an integer greater than 1. The process of establishing the data correlation includes: generating a variation relationship curve between exhaust pressure or flow rate and oil temperature of each of the N unit time intervals according to the status information and converting the variation relationship curves between exhaust pressure or flow rate and oil temperature into a standard reference curve that is adapted to the transformer. The process of determining whether the air cell has the rupture abnormality includes: setting a pressure or flow rate reference value corresponding to a first predetermined oil temperature according to the standard reference curve; and determining whether an actual exhaust pressure or flow rate of the air cell is lower than the pressure or flow rate reference value when an actual oil temperature of the insulating oil reaches the first predetermined oil temperature, and if yes, determining that the air cell has the rupture abnormality.

In one of the possible or preferred embodiments, the process of establishing the data correlation includes correcting or modifying the standard reference curve using a machine learning model trained on the status information.

In one of the possible or preferred embodiments, after the process of performing the rupture early warning for the air cell, the air-cell rupture diagnosis method further includes: setting a pressure or flow rate warning value corresponding to a second predetermined oil temperature according to the conversion relationship between air parameter and oil temperature; determining whether another actual exhaust pressure or flow rate of the air cell is lower than the pressure or flow rate warning value when another actual oil temperature of the insulating oil reaches the second predetermined oil temperature; and reducing a load rate of the transformer when the another actual exhaust pressure or flow rate of the air cell is lower than the pressure or flow rate warning value.

In order to solve the above-mentioned problems, another one of the technical aspects adopted by the present disclosure is to provide an air-cell rupture diagnosis system for an oil storage device of a transformer, which includes an insulating oil and an air cell configured to isolate the insulating oil from the atmosphere. The air-cell rupture diagnosis system includes a sensing module, an analysis device, and a diagnosis device. The sensing module is disposed on the oil storage device. The analysis device is connected to the sensing module. The diagnosis device is connected to the analysis device. The sensing module is configured to acquire status information of the oil storage device within at least one unit time interval, and the status information includes exhaust data of the air cell and oil temperature data of the insulating oil. The analysis device is configured to establish a data correlation based on the status information, and the data correlation defines a conversion relationship between air parameter and oil temperature. The diagnosis device is configured to perform rupture early warning for the air cell during operation of the transformer according to the conversion relationship between air parameter and oil temperature.

In one of the possible or preferred embodiments, the diagnosis device is configured to determine whether the air cell has a rupture abnormality according to the conversion relationship between air parameter and oil temperature, and to issue an early warning message when the air cell is determined to have the rupture abnormality. The air parameter is exhaust pressure or flow rate.

In one of the possible or preferred embodiments, the at least one unit time interval includes N unit time intervals, where N is an integer greater than 1. The analysis device is configured to generate a variation relationship curve between exhaust pressure or flow rate and oil temperature of each of the N unit time intervals according to the status information, and to convert the variation relationship curve between exhaust pressure or flow rate and oil temperatures into a standard reference curve adapted to the transformer. Furthermore, the diagnosis device is configured to set a pressure or flow rate reference value corresponding to a first predetermined oil temperature according to the standard reference curve, to determine whether an actual exhaust pressure or flow rate of the air cell is lower than the pressure or flow rate reference value when an actual oil temperature of the insulating oil reaches the first predetermined oil temperature, and if yes, to determine that the air cell has the rupture abnormality.

In one of the possible or preferred embodiments, after generating the standard reference curve, the analysis device is configured to correct or modify the standard reference curve using a machine learning model trained on the status information.

In one of the possible or preferred embodiments, after performing the rupture early warning for the air cell, the diagnosis device is configured to set a pressure or flow rate warning value corresponding to a second predetermined oil temperature according to the conversion relationship between air parameter and oil temperature, to determine whether another actual exhaust pressure or flow rate of the air cell is lower than the pressure or flow rate warning value when another actual oil temperature of the insulating oil reaches the second predetermined oil temperature, and if yes, to notify a control center to reduce a load rate of the transformer.

In conclusion, the air-cell rupture diagnosis method and system provided by the present disclosure can provide a dedicated exhaust abnormality determination standard for each transformer in a power system, thereby enabling prompt detection of air cell rupture abnormalities, by virtue of acquiring status information of the oil storage device within at least one unit time interval, the status information including exhaust data of the air cell and oil temperature data of the insulating oil, establishing a data correlation based on the status information to define a conversion relationship between air parameter and oil temperature, and performing rupture early warning for the air cell during operation of the transformer according to the conversion relationship between air parameter and oil temperature. Therefore, the time required for abnormality elimination can be reduced, and the transformer can be prevented from being damaged to avoid the occurrence or expansion of damage.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a flowchart of an air-cell rupture diagnosis method of the present disclosure;

FIG. 2 is another flowchart of the air-cell rupture diagnosis method of the present disclosure;

FIG. 3 shows a variation relationship curve between air cell exhaust parameter and oil temperature generated in step S2 of the air-cell rupture diagnosis method of the present disclosure;

FIG. 4 is a schematic view showing a use state of an air-cell rupture diagnosis system of the present disclosure;

FIG. 5 is a schematic view showing another use state of the air-cell rupture diagnosis system of the present disclosure; and

FIG. 6 is a block diagram showing an operational arrangement of the air-cell rupture diagnosis system of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### First Embodiment

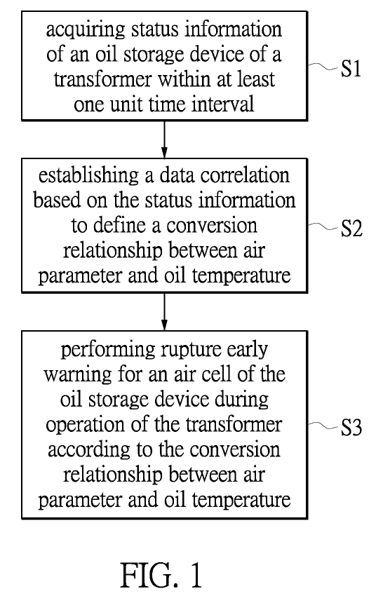

Referring to FIG. 1, a first embodiment of the present disclosure provides an air-cell rupture diagnosis method, which can be used to monitor operating status of an air cell in an oil storage device of a transformer, including air intake status and air exhaust status, and to promptly detect a rupture abnormality of the air cell, thereby performing early warning and responsive actions. The air-cell rupture diagnosis method of the present disclosure mainly includes: step S1, acquiring status information of an oil storage device of a transformer within at least one unit time interval; step S2, establishing a data correlation based on the status information to define a conversion relationship between air parameter and oil temperature; and step S3, performing rupture early warning for an air cell of the oil storage device during operation of the transformer according to the conversion relationship between air parameter and oil temperature. Therefore, the present disclosure can provide a dedicated exhaust abnormality determination standard for each transformer in a power system to overcome differences in operating environments or conditions, thereby promptly detecting a rupture abnormality of an air cell.

In step S1, status information of the oil storage device can be acquired for one or more unit time intervals during the operation of the transformer. The unit time interval can be one or several hours, a day, a week, or even longer, which are provided merely for illustrative purposes and are not intended to limit the scope of applications of the present disclosure. More specifically, exhaust data of the air cell and oil temperature data of the oil storage device are sensed at regular intervals (e.g., at 10-minutes or 1-hour intervals) within each unit time interval. Therefore, the status information acquired in step S1 can include air parameter data and oil temperature data at different time points within each of the unit time intervals. Each time point refers to a time point that passes one or more predetermined time intervals, which can be set arbitrarily, from a starting time. The air parameter is, for example, exhaust pressure or flow rate.

In step S2, the exhaust data of the air cell and the oil temperature data of the oil storage device can be processed and analyzed, and their data patterns and features can be integrated to establish a model that represents the variation behavior of the air parameter (such as pressure or flow rate) based on changes in oil temperature. The variation behavior can be represented as a conversion function relationship between air parameter and oil temperature to serve as a standard for determining whether the air cell has a rupture abnormality during the operation of the transformer. More specifically, the conversion function relationship between air parameter and oil temperature can be used to determine whether the value of the air parameter falls within a normal range when the air cell exhausts and an insulating oil reaches a specific temperature. If the value of the air parameter is abnormally low, the air cell is determined to have the rupture abnormality.

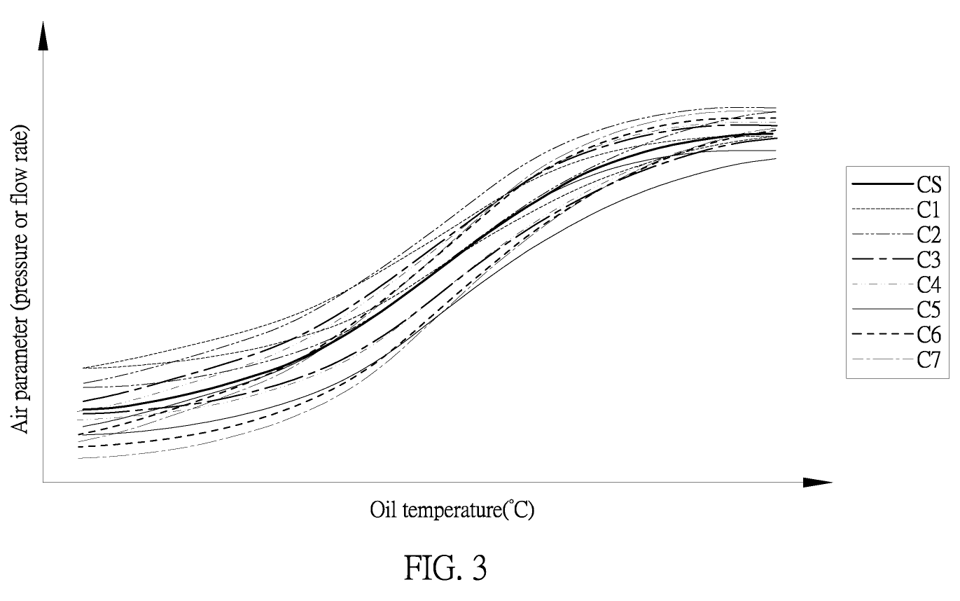

Reference is made to FIG. 3. In one of the possible embodiments, the status information of the oil storage device can be acquired for N days in step S1, where N is an integer greater than 1. The status information of the oil storage device includes exhaust data of the air cell and oil temperature data (i.e., exhaust parameter values of the air cell measured at different oil temperatures), which are recorded during a daily temperature rise period ranging from low to high temperatures (e.g., from 12:00 a.m. to 2:00 p.m.). In step S2, a variation relationship curve between air parameter (such as pressure or flow rate) and oil temperature of each day within the N days can be generated by data fitting. In the example of acquiring status information of the oil storage device for seven consecutive working days in step S1, a variation relationship curve C1 between air parameter and oil temperature of the first day, a variation relationship curve C2 between air parameter and oil temperature of the second day, a variation relationship curve C3 between air parameter and oil temperature of the third day, a variation relationship curve C4 between air parameter and oil temperature of the fourth day, a variation relationship curve C5 between air parameter and oil temperature of the fifth day, a variation relationship curve C6 between air parameter and oil temperature of the sixth day, and a variation relationship curve C7 between air parameter and oil temperature of the seventh day are generated in step S2.

Furthermore, a plurality of variation relationship curves generated in step S2 can be integrated into a standard reference curve CS, which is optimally adapted to the transformer and can serve as a standard for determining whether the air cell has a rupture abnormality during the operation of the transformer. More specifically, a pressure or flow rate reference value corresponding to a predetermined oil temperature can be set according to the standard reference curve CS. When an actual oil temperature of the insulating oil reaches the predetermined oil temperature, it is determined whether an actual exhaust pressure or flow rate of the air cell is lower than the pressure or flow rate reference value, and if yes, the air cell is determined to have a rupture abnormality.

In practice, a pre-trained machine learning model can be used to correct or modify the standard reference curve CS, such as modifying its curve range, curvature radius, or slope. Training data can include operating environment data of the transformer (e.g., surrounding environmental conditions), operating status data of the transformer (e.g., load data), and status data of the oil storage device (e.g., exhaust parameter values of the air cell measured at different oil temperatures).

It should be noted that the standard reference curve CS as shown in FIG. 3 is merely an example, and does not encompass all possible situations. The standard reference curves generated according to the present disclosure may vary depending on the characteristics of different transformers.

In step S3, the conversion relationship between air parameter and oil temperature established in step S2 is used to determine whether the air cell has a rupture abnormality. The determination steps can be implemented as described above, and a warning message is issued when the air cell is determined to have the rupture abnormality. If necessary, the warning message can include relevant data such as air cell exhaust data and oil temperature data.

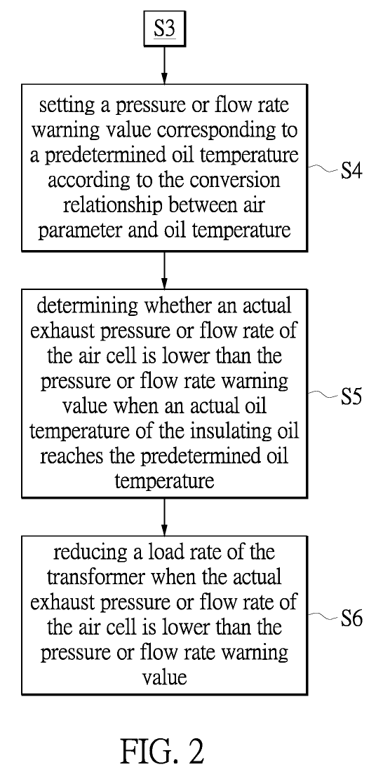

Reference is made to FIG. 2. The air-cell rupture diagnosis method of the present disclosure can further include: step S4, setting a pressure or flow rate warning value corresponding to a predetermined oil temperature according to the conversion relationship between air parameter and oil temperature; step S5, determining whether an actual exhaust pressure or flow rate of the air cell is lower than the pressure or flow rate warning value when an actual oil temperature of the insulating oil reaches the predetermined oil temperature; and step S6, reducing a load rate of the transformer when the actual exhaust pressure or flow rate of the air cell is lower than the pressure or flow rate warning value. Therefore, transformer failures can be prevented, so as to ensure the safe and stable operation of the power system.

### Second Embodiment

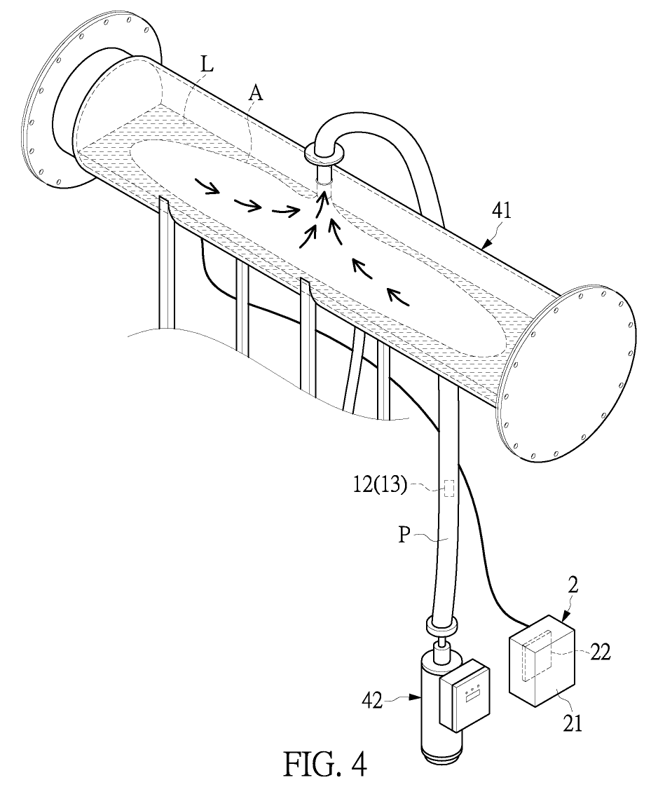

Referring to FIG. 4 to FIG. 6, a second embodiment of the present disclosure provides an air-cell rupture diagnosis system Z for implementing the above-described method, which includes a sensing module 1, an analysis device 2, and a diagnosis device 3. The sensing module is disposed on an oil storage device 41 of a transformer 4 to acquire status information of the oil storage device 41. The analysis device 2 is connected to the sensing module 1 to analyze the status information of the oil storage device 41, thereby establishing a data pattern construction model to represent a data correlation, which defines a conversion relationship between air parameter and oil temperature. The diagnosis device 3 is connected to the analysis device 2 to perform rupture diagnosis and early warning for an air cell A in the oil storage device 41, based on the data correlation derived from the status information of the oil storage device 41.

In the present embodiment, the sensing module 1 can be disposed on a gas flow path, and is configured to acquire status information of the oil storage device 41 within at least one unit time interval, which includes exhaust data of the air cell A and oil temperature data of an insulating oil L. The analysis device 2 includes a processing module 22. The processing module 22 is configured to establish a conversion relationship between air parameter (such as pressure or flow rate) and oil temperature based on the status information acquired by the sensing module 1. More specifically, the processing module 22 can analyze data features and key patterns within the data to establish a model that represents the variation behavior of the air parameter based on changes in oil temperature. The model can use an nth-order polynomial to describe the conversion function relationship between air parameter and oil temperature. The diagnosis device 3 is connected to the processing module 22, and is configured to perform rupture early warning for the air cell A during operation of the transformer 4 according to the conversion relationship between air parameter and oil temperature.

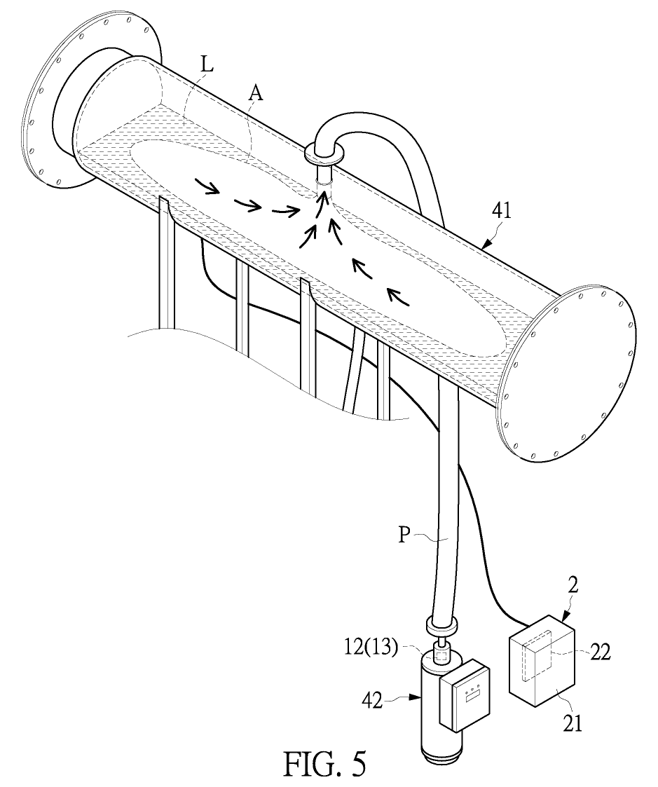

In practice, as shown in FIG. 4 and FIG. 5, the air cell A can be in gas communication with the external atmosphere through a breather 42, in which a pipeline P is disposed between the air cell A and the breather 42. The breather 42 is configured to remove moisture from the air to ensure that the air cell A draws in dry air. The sensing module 1 can include an oil temperature sensor 11, a pressure sensor 12, and a flow sensor 13. The oil temperature sensor 11 (such as an infrared temperature sensor) can measure the top-layer oil temperature of the insulating oil L in a non-contact manner through a proper configuration. The pressure sensor 12 and the flow sensor 13 can be installed in the pipeline P or inside the breather 42, either independently or integrally with each other, but the present disclosure is not limited thereto. The processing module 22 can be a processing unit of a microcontroller or a general-purpose or special-purpose processor, but is not limited thereto.

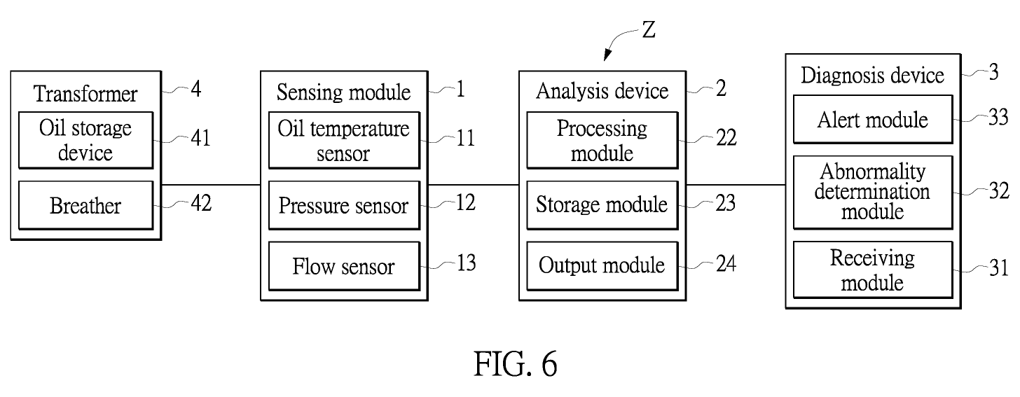

As shown in FIG. 6, the analysis device 2 can further include a storage module 23 and an output module 24. The storage module 23 is configured to store large volumes of data and conversion parameters, mapping relationships, equations, curves, and/or models generated from data analysis. The storage module 23 can be, but is not limited to, a storage unit of the microcontroller or any form of memory. The output module 24 is configured to transmit data and outputs of data analysis to the diagnosis device 3. The output module 24 can be, but is not limited to, a communication module or an output interface.

Preferably, the analysis device 2 can include an enclosure 21 disposed in proximity to the oil storage device 41. The processing module 22, the storage module 23, and the output module 24 can be integrated within the enclosure 21. For example, a circuit board is installed inside the enclosure 21, and the processing module 22, the storage module 23, and the output module 24 are integrated on the circuit board.

The diagnosis device 3 can communicate with the analysis device 2 via a wired or wireless network. The diagnosis device 3 can include a receiving module 31, an abnormality determination module 32, and an alert module 33. Each of these modules can be implemented in software, hardware, or firmware. The receiving module 31 is configured to receive data and outputs of data analysis from the analysis device 2. The abnormality determination module 32 is configured to determine, according to the conversion relationship between air parameter (such as pressure or flow rate) and oil temperature which is derived from data analysis, whether the air cell A in the oil storage device 41 has a rupture abnormality during operation of the transformer 4. The alert module 33 is configured to issue a warning message when the air cell A is determined to have the rupture abnormality.

In practice, the diagnosis device 3 can be implemented on a network-enabled computer device. For example, the diagnosis device 3 is operated on the computer device, but the present disclosure is not limited thereto. The diagnosis device 3 can access and utilize data on the analysis device 2 during the execution of a software application. Alternatively, the analysis device 2 can either actively transmit data to the receiving module 31 via the output module 24, or transmit data to the receiving module 31 via the output module 24 after receiving a query command from the receiving module 31.

Reference is made to FIG. 3. In one of the possible embodiments, the sensing module 1 is configured to acquire status information of the oil storage device 41 for N days, where N is an integer greater than 1. The status information of the oil storage device 41 includes exhaust data of the air cell and oil temperature data (i.e., exhaust parameter values of the air cell measured at different oil temperatures), which are recorded at different time points within a specific time period of each day. The processing module 22 of the analysis device 2 is configured to perform a data fitting treatment to generate a variation relationship curve between air parameter (such as pressure or flow rate) and oil temperature of each day within the N days, and to convert these variation relationship curves into a standard reference curve CS that is optimally adapted to the transformer 4. The abnormality determination module 32 of the diagnosis device 3 is configured to set a pressure or flow rate reference value corresponding to a predetermined oil temperature according to the standard reference curve CS, to determine whether an actual exhaust pressure or flow rate of the air cell A is lower than the pressure or flow rate reference value when an actual oil temperature of the insulating oil L reaches the predetermined oil temperature, and if yes, to determine that the air cell A has the rupture abnormality.

In practice, the diagnosis device 3 is configured to correct or modify the standard reference curve CS using a pre-trained machine learning model, such as modifying its curve range, curvature radius, or slope. Training data can include operating environment data of the transformer (e.g., surrounding environmental conditions), operating status data of the transformer (e.g., load data), and status data of the oil storage device (e.g., exhaust parameter values of the air cell measured at different oil temperatures).

In the present disclosure, the diagnosis device 3 can implement the following control measures to reduce the failure risk of the transformer 4. The diagnosis device 3 is configured to set a pressure or flow rate warning value corresponding to a predetermined oil temperature according to the conversion relationship between air parameter and oil temperature (or the standard reference curve CS), to determine whether an actual exhaust pressure or flow rate of the air cell A is lower than the pressure or flow rate warning value when an actual oil temperature of the insulating oil L reaches the predetermined oil temperature, and if yes, to notify a control center to reduce a load rate of the transformer 4.

### Beneficial Effects of the Embodiments

In conclusion, the air-cell rupture diagnosis method and system provided by the present disclosure can provide a dedicated exhaust abnormality determination standard for each transformer in a power system, thereby enabling prompt detection of air cell rupture abnormalities, by virtue of acquiring status information of the oil storage device within at least one unit time interval, the status information including exhaust data of the air cell and oil temperature data of the insulating oil, establishing a data correlation based on the status information to define a conversion relationship between air parameter and oil temperature, and performing rupture early warning for the air cell during operation of the transformer according to the conversion relationship between air parameter and oil temperature. Therefore, the time required for abnormality elimination can be reduced, and the transformer can be prevented from being damaged to avoid the occurrence or expansion of damage.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An air-cell rupture diagnosis method for an oil storage device of a transformer, which includes an insulating oil and an air cell configured to isolate the insulating oil from the atmosphere, the air-cell rupture diagnosis method comprising:
acquiring status information of the oil storage device within at least one unit time interval, the status information including exhaust data of the air cell and oil temperature data of the insulating oil;
establishing a data correlation based on the status information, the data correlation defining a conversion relationship between air parameter and oil temperature; and
performing rupture early warning for the air cell during operation of the transformer according to the conversion relationship between air parameter and oil temperature.

2. The air-cell rupture diagnosis method to claim 1, wherein the process of performing the rupture early warning for the air cell includes:
determining whether the air cell has a rupture abnormality according to the conversion relationship between air parameter and oil temperature, wherein the air parameter is exhaust pressure or flow rate; and
issuing an early warning message when the air cell is determined to have the rupture abnormality.

3. The air-cell rupture diagnosis method to claim 2, wherein, after the process of performing the rupture early warning for the air cell, the air-cell rupture diagnosis method further comprises:
setting a pressure or flow rate warning value corresponding to a predetermined oil temperature according to the conversion relationship between air parameter and oil temperature; and
determining whether an actual exhaust pressure or flow rate of the air cell is lower than the pressure or flow rate warning value when an actual oil temperature of the insulating oil reaches the predetermined oil temperature; and
reducing a load rate of the transformer when the actual exhaust pressure or flow rate of the air cell is lower than the pressure or flow rate warning value.

4. The air-cell rupture diagnosis method to claim 2, wherein the at least one unit time interval includes N unit time intervals, where N is an integer greater than 1; wherein the process of establishing the data correlation includes generating a variation relationship curve between exhaust pressure or flow rate and oil temperature of each of the N unit time intervals according to the status information, and to convert the variation relationship curve between exhaust pressure or flow rate and oil temperatures into a standard reference curve adapted to the transformer; and wherein the process of determining whether the air cell has the rupture abnormality includes:
setting a pressure or flow rate reference value corresponding to a first predetermined oil temperature according to the standard reference curve; and
determining whether an actual exhaust pressure or flow rate of the air cell is lower than the pressure or flow rate reference value when an actual oil temperature of the insulating oil reaches the first predetermined oil temperature, and if yes, determining that the air cell has the rupture abnormality.

5. The air-cell rupture diagnosis method to claim 4, wherein, after the process of performing the rupture early warning for the air cell, the air-cell rupture diagnosis method further comprises:
setting a pressure or flow rate warning value corresponding to a second predetermined oil temperature according to the standard reference curve; and
determining whether another actual exhaust pressure or flow rate of the air cell is lower than the pressure or flow rate warning value when another actual oil temperature of the insulating oil reaches the second predetermined oil temperature; and
reducing a load rate of the transformer when the another actual exhaust pressure or flow rate of the air cell is lower than the pressure or flow rate warning value.

6. The air-cell rupture diagnosis method to claim 4, wherein the process of establishing the data correlation includes correcting or modifying the standard reference curve using a machine learning model trained on the status information.

7. The air-cell rupture diagnosis method to claim 6, wherein, after the process of performing the rupture early warning for the air cell, the air-cell rupture diagnosis method further comprises:
setting a pressure or flow rate warning value corresponding to a second predetermined oil temperature according to the standard reference curve; and
determining whether another actual exhaust pressure or flow rate of the air cell is lower than the pressure or flow rate warning value when another actual oil temperature of the insulating oil reaches the second predetermined oil temperature; and
reducing a load rate of the transformer when the another actual exhaust pressure or flow rate of the air cell is lower than the pressure or flow rate warning value.

8. An air-cell rupture diagnosis system for an oil storage device of a transformer, which includes an insulating oil and an air cell configured to isolate the insulating oil from the atmosphere, the air-cell rupture diagnosis system comprising:
a sensing module disposed on the oil storage device, wherein the sensing module is configured to acquire status information of the oil storage device within at least one unit time interval, and the status information includes exhaust data of the air cell and oil temperature data of the insulating oil;
an analysis device connected to the sensing module, wherein the analysis device is configured to establish a data correlation based on the status information, and the data correlation defines a conversion relationship between air parameter and oil temperature; and
a diagnosis device connected to the analysis device, wherein the diagnosis device is configured to perform rupture early warning for the air cell during operation of the transformer according to the conversion relationship between air parameter and oil temperature.

9. The air-cell rupture diagnosis system to claim 8, wherein the diagnosis device is configured to determine whether the air cell has a rupture abnormality according to the conversion relationship between air parameter and oil temperature, and to issue an early warning message when the air cell is determined to have the rupture abnormality; and wherein the air parameter is exhaust pressure or flow rate.

10. The air-cell rupture diagnosis system to claim 9, wherein, after performing the rupture early warning for the air cell, the diagnosis device is configured to set a pressure or flow rate warning value corresponding to a predetermined oil temperature according to the conversion relationship between air parameter and oil temperature, to determine whether an actual exhaust pressure or flow rate of the air cell is lower than the pressure or flow rate warning value when an actual oil temperature of the insulating oil reaches the predetermined oil temperature, and if yes, to notify a control center to reduce a load rate of the transformer.

11. The air-cell rupture diagnosis system to claim 9, wherein the at least one unit time interval includes N unit time intervals, where N is an integer greater than 1; wherein the analysis device is configured to generate a variation relationship curve between exhaust pressure or flow rate and oil temperature of each of the N unit time intervals according to the status information, and to convert the variation relationship curve between exhaust pressure or flow rate and oil temperatures into a standard reference curve adapted to the transformer; and wherein the diagnosis device is configured to set a pressure or flow rate reference value corresponding to a first predetermined oil temperature according to the standard reference curve, to determine whether an actual exhaust pressure or flow rate of the air cell is lower than the pressure or flow rate reference value when an actual oil temperature of the insulating oil reaches the first predetermined oil temperature, and if yes, to determine that the air cell has the rupture abnormality.

12. The air-cell rupture diagnosis system to claim 11, wherein, after performing the rupture early warning for the air cell, the diagnosis device is configured to set a pressure or flow rate warning value corresponding to a second predetermined oil temperature according to the standard reference curve, to determine whether another actual exhaust pressure or flow rate of the air cell is lower than the pressure or flow rate warning value when another actual oil temperature of the insulating oil reaches the second predetermined oil temperature, and if yes, to notify a control center to reduce a load rate of the transformer.

13. The air-cell rupture diagnosis system to claim 11, wherein, after generating the standard reference curve, the analysis device is configured to correct or modify the standard reference curve using a machine learning model trained on the status information.

14. The air-cell rupture diagnosis system to claim 13, wherein, after performing the rupture early warning for the air cell, the diagnosis device is configured to set a pressure or flow rate warning value corresponding to a second predetermined oil temperature according to the standard reference curve, to determine whether another actual exhaust pressure or flow rate of the air cell is lower than the pressure or flow rate warning value when another actual oil temperature of the insulating oil reaches the second predetermined oil temperature, and if yes, to notify a control center to reduce a load rate of the transformer.
